(19) United States
(12) Patent Application Publication
(10) Pub. No.: US 2007/0097564 A1
(43) Pub. Date: May 3, 2007

(54) Electronic apparatus

(75) Inventor: Takayuki Kado, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRONIC CO., LTD., Echizen-city (JP)

(21) Appl. No.: 11/585,834

(22) Filed: Oct. 25, 2006

(30) Foreign Application Priority Data
Oct. 27, 2005 (JP) 2005-312502

(51) Int. Cl. H02H 7/00

(52) U.S. Cl. 361/18

(57) ABSTRACT

An electronic apparatus is provided which prevents, when timer programming is set, continuation of a state in which an outside power supply is stopped. A power supply section 21 converts a power supply from outside to a waveform (direct current) and a voltage to be used inside. When power is supplied to the power supply section 21, a standby power supply section 22 is charged. An alarm section 28 outputs an alarm to the user. A control section 29 controls a whole electronic apparatus 20 and includes a clock section which counts a date and time and a memory section which stores timer programming information. A SW3 (32) is the switch which turns ON/OFF the power supply to the alarm section 28, is normally set to OFF, but the control section 29 turns ON this switch when outputting an alarm.

The present application is based on and claims priority of Japanese patent application No. 2005-312502 filed on Oct. 27, 2005, the entire contents of which are hereby incorporated by reference.

### BACKGROUND OF THE INVENTION

1. Field of the Invention

The present invention relates to an electronic apparatus which supplies power from a built-in standby power supply section when a power supply from outside stops, and more particularly, to a recording apparatus provided with an inner clock and a timer programming function which protects timer programmed contents by supplying power from a standby power supply section when the power supply from outside is stopped due to a power failure or coming-off of a power supply plug or the like.

2. Description of the Related Art

In recent years, there is a growing demand for energy saving and while the development of electronic apparatuses with low power consumption and small standby electric power is underway, users often use a table tap with a switch to stop the power supply to the electronic apparatus to avoid consumption of standby electric power. Therefore, there is a growing danger that even when timer programming is set, the power supply to the electronic apparatus may be stopped and timer programming may not be executed.

Japanese Patent Laid-Open Publication No. 11-41806 (patent document 1) discloses a technology of supplying power from a built-in standby power supply section when a power supply from outside stops. According to this technology, a clock and timer programming data inside the electronic apparatus can be protected, and therefore even when, for example, the switch of a table tap is turned off by mistake and the power supply from outside is stopped, if the switch of the table tap is immediately turned on, the timer programming from that time on is executed without any problem.

An electronic apparatus equipped with a timer programming function such as a recording apparatus is generally designed to be placed in a standby state when power is turned off by operating a power button so as to supply power to parts necessary to control the electronic apparatus itself from a power supply section and parts storing data whose resetting in the event of loss would be troublesome. Moreover, even when a power supply stops due to a power failure or the like and power can no longer be supplied from the power supply section, power is supplied from a built-in standby power supply section to parts necessary to control the electronic apparatus itself and parts storing data whose resetting in the event of loss would be troublesome. For example, in a recording apparatus such as a video cassette recorder, while power is supplied from a built-in standby power supply section to sections with low power consumption such as a control section (including a clock section which counts a date and time and a memory section which stores channel information and timer programmed contents), power is not supplied to sections with high power consumption such as a main device section (section which performs main operations such as recording and reproducing and includes a drive device such as a motor in the apparatus). Therefore, the technology described in patent document 1 has a problem that even when timer programming is set, the user may misunderstand that timer programming has not been done and the time set by the timer programming may be past with the outside power supply being stopped and the timer programming may not be executed.

### SUMMARY OF THE INVENTION

The present invention has been implemented in view of the above described problem and it is an object of the present invention to provide an electronic apparatus which prevents, when timer programming is set, continuation of a state in which a power supply from outside is stopped.

The electronic apparatus according to a first aspect of the present invention is an electronic apparatus comprising a main device section which performs main operations of the electronic apparatus, a power supply section which changes a power supply from outside the electronic apparatus to a power supply used inside the electronic apparatus and supplies the power to inside the electronic apparatus, a standby power supply section which performs charging using the power supplied from the power supply section when power is supplied to the power supply section from outside the electronic apparatus and supplies power, when power is no longer supplied from outside the electronic apparatus, to parts inside the electronic apparatus requiring power and a control section which controls the main device section, the power supply section and the standby power supply section, the control section comprising a function for timer programming of operations of the main device section, the control section changing, when stoppage of the power supply to the power supply section is detected, a source of the power supply to the control section from the power supply section to the standby power supply section and changing, when resumption of the power supply to the power supply section is detected, the source of the power supply to the control section from the standby power supply section to the power supply section, wherein an alarm section which outputs an alarm is provided, and when the control section detects stoppage of the power supply to the power supply section and timer programming for operating the main device section is set, the control section starts a power supply from the standby power supply section to the alarm section, causes the alarm section to start alarming, or causes, when the resumption of the power supply to the power supply section is detected, the alarm section to stop alarming and stops the power supply from the standby power supply section to the alarm section.

According to the electronic apparatus according to the first aspect of the present invention, if timer programming has been set when the outside power supply is stopped, it is possible to reduce the possibility that timer programming may not be executed by outputting an alarm to call the user's attention and preventing continuation of a state in which the power supply from outside is stopped.

The electronic apparatus according to a second aspect of the present invention is an electronic apparatus comprising a main device section which performs main operations of the electronic apparatus, a power supply section which changes a power supply from outside the electronic apparatus to a power supply used inside the electronic apparatus and supplies the power to inside the electronic apparatus, a standby power supply section which performs charging using the power supplied from the power supply section when power is supplied to the power supply section from outside the electronic apparatus and supplies power, when power is no longer supplied from outside the electronic apparatus, to parts inside the electronic apparatus requiring power and a control section which controls the main device section, the power supply section and the standby power supply section, the control section comprising a function for timer programming of operations of the main device section, the control section changing, when stoppage of the power supply to the power supply section is detected, a source of the power supply to the control section from the power supply section to the standby power supply section and changing, when resumption of the power supply to the power supply section is detected, the source of the power supply to the control section from the standby power supply section to the power supply section, wherein an alarm section which outputs an alarm is provided, and when the control section detects stoppage of the power supply to the power supply section and timer programming for operating the main device section is set after the time of the detection until a predetermined time elapses, the control section starts a power supply from the standby power supply section to the alarm section, causes the alarm section to start alarming, or causes, when the resumption of the power supply to the power supply section is detected, the alarm section to stop alarming and stops the power supply from the standby power supply section to the alarm section.

According to the electronic apparatus according to the second aspect of the present invention, if timer programming has been set when the power supply from outside is stopped, it is possible to reduce the possibility that timer programming may not be executed by outputting an alarm to call the user's attention and preventing continuation of a state in which the outside power supply is stopped. Moreover, when there is a time equal to or longer than a predetermined time A until the timer programmed time, it is possible to reduce the frequency of occurrence of alarms by preventing alarms from being output (more specifically, when, for example, a state in which power is not turned ON never continues for 1 week or more (that is, power is turned ON again within at least 1 week), if 1 week is set as the predetermined time A, no alarm is output if timer programming is set to be effective after 1 week or later, but it is expected that power will be turned ON again within 1 week, and therefore there is no problem in practical use).

The electronic apparatus according to a third aspect of the present invention is the electronic apparatus according to the first or second aspect of the present invention, wherein the control section comprises a function for measuring an elapsed time, causes, when the power supply to the power supply section is not resumed even after the lapse of a predetermined time from the time at which stoppage of the power supply to the power supply section is detected, the alarm section to stop alarming, and stops the power supply from the standby power supply section to the alarm section.

According to the electronic apparatus according to the third aspect of the present invention, an alarm is output for the predetermined time C at the longest, and therefore it is possible to prevent an alarm from being output continuously for all time.

According to the present invention, if timer programming has been set when the power supply from outside is stopped, it is possible to provide an electronic apparatus which reduces the possibility that timer programming may not be executed by outputting an alarm to call the user's attention and preventing continuation of a state in which the power supply from outside is stopped.

### BRIEF DESCRIPTION OF THE DRAWINGS

FIG. 1 illustrates the configuration of an embodiment;

FIG. 2 shows a flow chart illustrating operations of the embodiment; and

FIG. 3 shows the configuration of a conventional electronic apparatus.

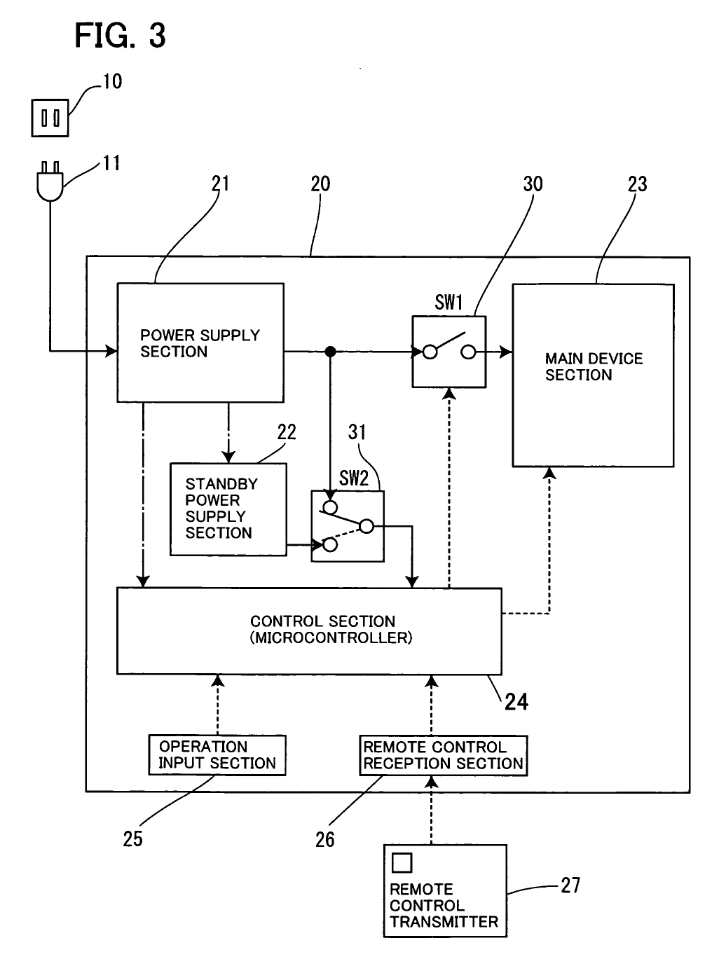

### DETAILED DESCRIPTION OF THE PREFERRED EMBODIMENTS

An embodiment of the present invention will be explained with reference to the attached drawings. It should be noted that the following embodiment is nothing more than a specific example of the present invention and the present invention is not limited to the following embodiment.

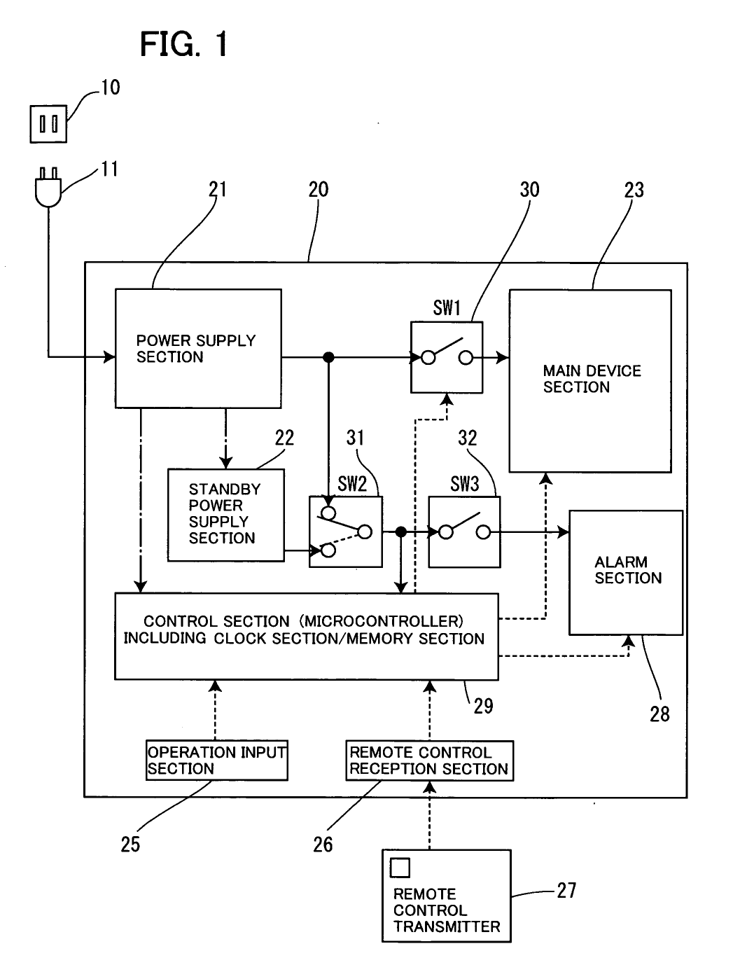

FIG. 1 shows the configuration of an electronic apparatus 20 of this embodiment. This electronic apparatus 20 is provided with a power supply section 21, a standby power supply section 22, a main device section 23, an operation input section 25, a remote control reception section 26, an alarm section 28, a control section 29, SW1 (30), SW2 (31), SW3 (32).

When a power supply plug 11 is connected to a receptacle 10, power is supplied to the power supply section 21 inside the electronic apparatus 20. The power supply section 21 converts the outside power to a waveform (direct current) and a voltage to be used inside and supplies it to the respective sections. When power is supplied to the power supply section 21, the standby power supply section 22 is charged. The main device section 23 is the section which performs main operations of this electronic apparatus 20. The operation input section 25 transmits operation information on buttons (power key or the like) provided for this electronic apparatus 20 to the control section 29. The remote control reception section 26 receives information transmitted from a remote control transmitter 27 and transmits it to the control section 29. The alarm section 28 outputs an alarm to the user. The control section 29 is made up of a microcontroller, controls the whole electronic apparatus 20 and includes a clock section which counts a date and time and a memory section which stores timer programming information.

The SW1 (30) is the switch which turns ON/OFF power from the power supply section 21 to the main device section 23 and is set to ON in a normal condition, but the control section 29 turns OFF this switch in a standby state and when stoppage of an outside power supply to the power supply section 21 is detected. The SW2 (31) is the switch which switches whether the source of power supply to the control section 29 should be the power supply section 21 or the standby power supply section 22 and the power supply section 21 is selected in a normal condition, but when stoppage of the outside power supply to the power supply section 21 is detected, the control section 29 selects the standby power supply section 22. The SW3 (32) is the switch which turns ON/OFF the power supply to the alarm section 28 and is set to OFF in a normal condition, but when an alarm is output, the control section 29 turns ON this switch.

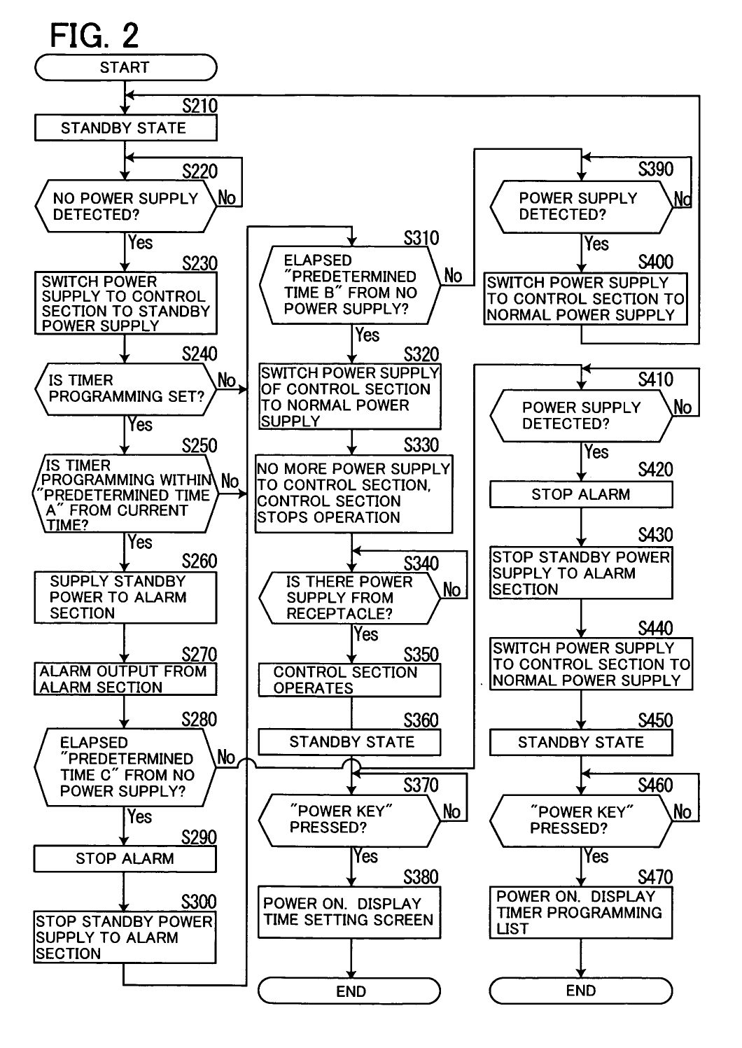

Operations of the electronic apparatus in such a configuration will be explained using the flow chart shown in FIG. 2.

The electronic apparatus 20 is normally in a standby state in step S210. In next step S220, the control section 29 judges whether or not stoppage of the power supply from outside to the power supply section 21 is detected and moves to step S230 when stoppage is detected or moves to step S220 otherwise.

In step S230, the control section 29 operates the SW2 (31) to switch the source of the power supply to the control section 29 from the power supply section 21 to the standby power supply section 22 and moves to step S240. In step S240, the control section 29 judges whether or not timer programming is set and moves to step S250 when timer programming is set or moves to step S310 otherwise.

In step S250, the control section 29 judges whether or not there is timer programming within a “predetermined time A”, and moves to step S260 when there is timer programming or moves to step S310 otherwise.

In step S260, the control section 29 turns ON the SW3 (32) to cause the standby power supply section 22 to supply power to the alarm section 28, and in next step S270, the control section 29 causes the alarm section 28 to start alarming and moves to step S280.

In step S280, the control section 29 judges whether or not a “predetermined time C” has passed after the outside power supply is stopped and moves to step S290 when the predetermined time C has passed or moves to step S410 otherwise.

In step S290, the control section 29 causes the alarm section 28 to stop alarming, and in next step S300, the control section 29 turns OFF the SW3 (32) and stops the power supply to the alarm section 28 from the standby power supply section 22 and moves to step S310.

In step S310, the control section 29 judges whether or not a “predetermined time B” has passed after stoppage of the power supply from outside is detected and moves to step S320 when the passage of the “predetermined time B” is detected, or moves to step S390 otherwise.

In step S320, the control section 29 operates the SW2 (31) to switch the source of the power supply to the control section 29 from the standby power supply section 22 to the power supply section 21, and in next step S330, the power supply to the control section 29 is stopped, the operation of the control section stops and the control section 29 moves to step S340.

In step S340, when the power supply from outside is resumed, the control section 29 moves to step S350 or moves to step S340 otherwise.

In step S350, the control section 29 resumes operation and in next step S360, the electronic apparatus 20 is placed in a standby state and the control section 29 moves to step S370.

In step S370, the control section 29 judges whether or not the “power key” of the operation input section 25 or the remote control transmitter 27 has been pressed and moves to step S380 when the power key has been pressed or moves to step S370 otherwise.

In step S380, the control section 29 turns ON the power of the electronic apparatus 20, displays a time setting screen, and then moves to the “end.”

In step S390, the control section 29 judges whether or not the resumption of the power supply from outside is detected and the control section 29 moves to step S400 when the resumption of the power supply is detected or moves to step S390 otherwise.

In step S400, the control section 29 operates the SW2 (31) to switch the source of the power supply to the control section 29 from the standby power supply section 22 to the power supply section 21 and moves to step S210.

In step S410 the control section 29 judges whether or not the resumption of the power supply from outside is detected and the control section 29 moves to step S420 when the resumption of the power supply is detected or moves to step S410 otherwise.

In step S420, the control section 29 causes the alarm section 28 to stop alarming, and in next step S430, the control section 29 turns OFF the SW3 (32) to stop the power supply to the alarm section 28 from the standby power supply section 22 and moves to step S440.

In step S440, the control section 29 operates the SW2 (31) to switch the source of the power supply to the control section 29 from the standby power supply section 22 to the power supply section 21, and in next step S450, the electronic apparatus 20 is placed in a standby state and the control section 29 moves to step S460.

In step S460, the control section 29 judges whether or not the “power key” of the operation input section 25 or the remote control transmitter 27 has been pressed and the control section 29 moves to step S470 when the “power key” has been pressed or moves to step S460 otherwise.

In step S470, the control section 29 turns ON the power of the electronic apparatus 20, displays a timer programming list and then moves to the “end.”

In this way, if timer programming has been set when the outside power supply is stopped, an alarm is output to call the user's attention to prevent continuation of a state in which the outside power supply is stopped and it is thereby possible to provide an electronic apparatus which reduces the possibility that timer programming may not be executed.

Here, as the predetermined time A, 12 hours to 1 week or preferably 24 hours is used (even if the power supply is stopped, the power supply is considered to resume within 24 hours). As the predetermined time B, 10 minutes to 60 minutes or preferably 30 minutes is used (this is because the longer the time during which the power from the standby power supply section can be supplied, the better, but the amount of charge of the standby power supply section needs to be increased accordingly and this will result in an increase of cost, and the time during which the power from the standby power supply section can be supplied is generally often set to approximately 30 minutes). As the predetermined time C, 1 minute to 10 minutes or preferably 5 minutes is used (as the time for outputting an alarm, approximately 5 minutes is enough to call the user's attention).

As the method of alarming at the alarm section 28, it is possible to cause a light-emitting diode mounted in the main unit of the electronic apparatus 20 to blink or change a color or cause the display of the display section of the electronic apparatus 20 to blink or cause this display section to display an alarming message or output a sound (voice, music, buzzer, ringing sound or the like) or cause the electronic apparatus 20 itself to vibrate.

What is claimed is:

1. An electronic apparatus comprising:
a main device section which performs main operations of the electronic apparatus;
a power supply section which changes a power supply from outside the electronic apparatus to a power supply used inside the electronic apparatus and supplies the power to inside the electronic apparatus;
a standby power supply section which performs charging using the power supplied from the power supply section when power is supplied to the power supply section from outside the electronic apparatus and supplies power, when power is no longer supplied from outside the electronic apparatus, to parts inside the electronic apparatus requiring power; and
a control section which controls the main device section, the power supply section and the standby power supply section, the control section comprising a function for timer programming of operations of the main device section,
the control section changing, when stoppage of the power supply to the power supply section is detected, a source of the power supply to the control section from the power supply section to the standby power supply section and changing, when resumption of the power supply to the power supply section is detected, the source of the power supply to the control section from the standby power supply section to the power supply section,
wherein an alarm section which outputs an alarm is provided, and
when the control section detects stoppage of the power supply to the power supply section and timer programming for operating the main device section is set, the control section starts a power supply from the standby power supply section to the alarm section, causes the alarm section to start alarming, or causes, when the resumption of the power supply to the power supply section is detected, the alarm section to stop alarming and stops the power supply from the standby power supply section to the alarm section.

2. An electronic apparatus comprising:
a main device section which performs main operations of the electronic apparatus;
a power supply section which changes a power supply from outside the electronic apparatus to a power supply used inside the electronic apparatus and supplies the power to inside the electronic apparatus;
a standby power supply section which performs charging using the power supplied from the power supply section when power is supplied to the power supply section from outside the electronic apparatus and supplies power, when power is no longer supplied from outside the electronic apparatus, to parts inside the electronic apparatus requiring power; and
a control section which controls the main device section, the power supply section and the standby power supply section,
the control section comprising a function for timer programming of operations of the main device section,
the control section changing, when stoppage of the power supply to the power supply section is detected, a source of the power supply to the control section from the power supply section to the standby power supply section and changing, when resumption of the power supply to the power supply section is detected, the source of the power supply to the control section from the standby power supply section to the power supply section,
wherein an alarm section which outputs an alarm is provided. and
when the control section detects stoppage of the power supply to the power supply section and timer programming for operating the main device section is set after the time of the detection until a predetermined time elapses, the control section starts a power supply from the standby power supply section to the alarm section, causes the alarm section to start alarming, or causes, when the resumption of the power supply to the power supply section is detected, the alarm section to stop alarming and stops the power supply from the standby power supply section to the alarm section.

3. The electronic apparatus according to claim 1, wherein the control section comprises a function for measuring an elapsed time, causes, when the power supply to the power supply section is not resumed even after the lapse of a predetermined time from the time at which stoppage of the power supply to the power supply section is detected, the alarm section to stop alarming, and stops the power supply from the standby power supply section to the alarm section.

4. The electronic apparatus according to claim 2, wherein the control section comprises a function for measuring an elapsed time, causes, when the power supply to the power supply section is not resumed even after the lapse of a predetermined time from the time at which stoppage of the power supply to the power supply section is detected, the alarm section to stop alarming, and stops the power supply from the standby power supply section to the alarm section.
